(19) United States
(12) Patent Application Publication
(10) Pub. No.: US 2005/0253099 A1
(43) Pub. Date: Nov. 17, 2005

(54) Gate valve

(75) Inventors: Yoshio Osawa, Tokyo (JP); Koichi Mori, Tokyo (JP)

Correspondence Address: ARENT FOX PLLC, 1050 CONNECTICUT AVENUE, N.W., SUITE 400, WASHINGTON, DC, 20036, US

(73) Assignee: EAGLE INDUSTRY CO., LTD.

(21) Appl. No.: 11/128,334

(22) Filed: May 13, 2005

(30) Foreign Application Priority Data
May 17, 2004 (JP) 2004-145973

(51) Int. Cl. F16K 31/143

(52) U.S. Cl. 251/63

(57) ABSTRACT

A gate valve has a valve case formed with through holes at facing positions, a valve assembly having a pair of valve plates connected via bellows and arranged inside the valve case, a support rod for supporting this valve assembly at its front end, bellows for sealing the valve case side and support rod side, and air cylinders for making the valve assembly move between the open position and closed position through the support rod. The valve case is formed with an opening through which the valve assembly can pass and has a lid detachably attached to the valve case by bolts so as to close the opening. The bolts are tightened or loosened through the opening so that the valve assembly can be attached to or detached from the support rod.

### BACKGROUND OF THE INVENTION

1. Field of the Invention

The present invention relates to a gate valve for opening and closing various types of openings, for example relates to a gate valve able to air-tightly open and close an opening of a vacuum process chamber used for a process of production of a semiconductor device.

2. Description of the Related Art

In a dry etching step, sputtering step, epitaxial wafer forming step, etc. of a semiconductor production process, a transport passage for moving a wafer or other workpiece from one vacuum process chamber to another vacuum process chamber and an exhaust passage for connecting a high vacuum chamber and vacuum pump are provided with gate valves for securing the vacuum and cleanliness.

As this gate valve, it has been known in the past that a pair of valve plates which are connected via bellows are provided inside a valve case formed with through holes and movably supported by a support rod, and N₂ gas, compressed air, or another fluid are supplied to the bellows (for example, see Japanese Unexamined Patent Publication (Kokai) No. 01-261573), or mechanical extension/contraction mechanisms or piezoelectric actuators which are provided in the bellows are drove (for example, see Japanese Unexamined Patent Publication (Kokai) No. 05-106761), so that the valve plates move apart to seal the through holes.

In the above-mentioned gate valve, air-tightness is secured by interposing seal members between the valve plates and the circumferences of the through holes of the valve case. However, along with long-term use, the seal members deteriorate and the desired air-tightness can no longer be obtained. Accordingly, for example it is necessary to periodically replace the seal members for maintenance.

The seal members are attached to the valve plates themselves placed in the valve case or are attached around the through holes in the valve case. Therefore, when replacing the seal members in a gate valve of this structure, it was necessary to detach not only the valve plates, but also the support rod from the valve case, replace the seal members, then reassemble the valve plates and the support rod in the valve case. Accordingly, replacement of these parts and inspection work took an extremely large amount of labor.

### SUMMARY OF THE INVENTION

An object of the present invention is to provide a gate valve superior in maintainability.

To achieve the above object, the gate valve according to the present invention is provided with at least: a valve case formed with through holes at facing positions; a valve assembly having a pair of valve plates arranged in the valve case and a bellows connecting the pair of valve plates; a support rod for supporting the valve assembly and making the valve assembly move between a closed position where the valve plates face the through holes and an open position where the valve plates do not face the through holes; a valve plate driving means for making the pair of valve plates move away from or close to each other; and guiding means for guiding the valve plates along the direction in which the pair of valve plates move away from or close to each other; wherein the valve plate driving means is a fluid supplying means for supplying a fluid to a sealed space formed by the pair of valve plates and the bellows and discharging the fluid from the sealed space, the valve case is formed with an opening through which the valve assembly can be passed and is provided with a lid detachably attached to the valve case so as to close the opening, and the valve assembly can be attached to or detached from the support rod through the opening.

In the present invention, that is, there is provided a gate valve making a pair of valve plates move away from or close to each other to press the valve plates against the circumferences of the through holes of the valve case or separate them from the circumferences so as to open or close the through holes of the valve case, wherein an opening through which the valve assembly can be passed is formed in the valve case and a detachable lid for closing the opening is provided at the valve case.

Further, at the time of maintenance such as replacement of the seal members, first the lid is detached from the valve case so as to open the opening. Next, the valve assembly is detached from the support rod through that opening. Then, only the valve assembly is taken out from the gate valve through that opening. Due to this, maintenance can be performed easily without disassembling the gate valve as a whole. Further, along with this, problems such as changes in performance of the gate valve accompanying the overall reassembly work such as explained above no longer easily occur.

Further, in the present invention, the fluid supplying means supply or discharge fluid to or from the sealed space so that the pair of valve plates move away or close to each other, the valve plates press to or separate from the circumferences of the through holes of the valve case and open or close the through holes of the valve case. Due to this, compared with when employing a mechanical extension/contraction mechanism as a valve plate driving means, it is possible to reduce the number of parts of the valve assembly, so it becomes possible to improve the cleanliness and reliability of the valve and possible to reduce the size of the gate valve.

Further, in the present invention, the valve assembly further has guiding means for guiding the valve plates along the direction in which the pair of valve plates move away from or close to each other. Specifically, each guiding means includes a shaft arranged between the pair of valve plates, and bushes able to slide along the shaft and provided at the valve plates. The axial direction of the shaft preferably substantially matches with the direction in which the pair of valve plates move away from or close to each other.

By providing such guiding means for the gate valve, it is possible to prevent the weights of the valve plates themselves from causing the bellows to bend and buckle. Due to this, it becomes possible to accurately press the valve plates against the circumferences of the through holes, so it becomes possible to reliably secure the desired air-tightness.

In the above invention, while not particularly limited to this, the valve assembly preferably further has limiting means for limiting the distance of approach at the time of the operation for making the pair of valve plates move close to each other so that the folds of the bellows do not contact each other at the time of contraction. The distance of approach is more preferably longer than the free length of the bellows. Specifically, each limiting means includes a sleeve and a stopper block having lengths longer than the free length of the bellows. The sleeve and stopper block preferably are fastened to a corresponding shaft.

By providing the limiting means for the gate valve, it is possible to prevent the folds of the bellows sandwiching in foreign matter from contacting each other and damaging them, possible to prevent the valve plates from striking and damaging each other, and therefore possible to extend the service life of the valve assembly.

In the present invention, preferably each limiting means includes a stopper block holding the corresponding shaft, the stopper block is detachably connected with the support rod so that the valve assembly can be attached to or detached from the support rod, and the detachment of the stopper block from the support rod enables work through the opening of the valve case.

In this case, the stopper blocks used as the limiting means are jointly used as fastening means for fastening the valve assembly to the support rod, so it is possible to reduce the number of parts forming the gate valve and possible to reduce the size of the gate valve.

In the above invention, while not particularly limited to this, engagement parts able to engage with tools for taking out the valve assembly from the valve case are preferably provided at the opening side surfaces of the valve plates.

Specifically, the engagement parts are preferably internal threads able to be screwed with external threads formed at the front ends of the tools.

By forming engagement parts at the opening side surfaces of the valve plates in this way for taking out the valve assembly from the valve case, there is no longer a need to secure space for insertion of the hand etc. inside the valve case so as to take out the valve assembly from the valve case at the time of maintenance of the gate valve, so the gate valve can be reduced in size.

As explained above, according to the present invention, it is possible to provide a gate valve improved in maintainability.

### BRIEF DESCRIPTION OF THE DRAWINGS

Below, the present invention will be explained based on the illustrated embodiments with reference to the drawings, wherein:

FIG. 1 is a front view of a gate valve according to an embodiment of the present invention,

FIG. 2 is a side view of the gate valve shown in FIG. 1,

FIG. 3 is a front view of a valve assembly in the embodiment of the present invention,

FIG. 4 is a cross-sectional view of the valve assembly along the line IV-IV of FIG. 3,

FIG. 5A is a cross-sectional view of a valve assembly along the line V-V of FIG. 3 and shows the state of the through holes opened,

FIG. 5B is a cross-sectional view of a valve assembly along the line V-V of FIG. 3 and shows the state of the through holes closed,

FIG. 6 is a perspective view of a bush of a guiding means in the embodiment of the present invention,

FIG. 7 is a perspective view of a shaft and sleeve of a first guiding means according to the embodiment of the present invention,

FIG. 8A is a cross-sectional view of a valve assembly along the line VIII-VIII of FIG. 3 and shows the state of the through holes opened,

FIG. 8B is a cross-sectional view of a valve assembly along the line VIII-VIII of FIG. 3 and shows the state of the through holes closed,

FIG. 9 is a perspective view of a shaft and stopper block of a second guiding means according to the embodiment of the present invention,

FIG. 10 is a view of the state of moving the valve assembly of the gate valve shown in FIG. 1 to the open position,

FIG. 11 is a block diagram of a piping system of a gate valve according to the embodiment of the present invention,

FIG. 12 is a view of the method of maintenance of the gate valve according to the embodiment of the present invention and shows the state of detachment of the lid and valve assembly, and

FIG. 13 is a view of the method of maintenance of the gate valve according to the embodiment of the present invention and shows the state when the valve assembly is taken out from the valve case.

### DESCRIPTION OF THE PREFERRED EMBODIMENT

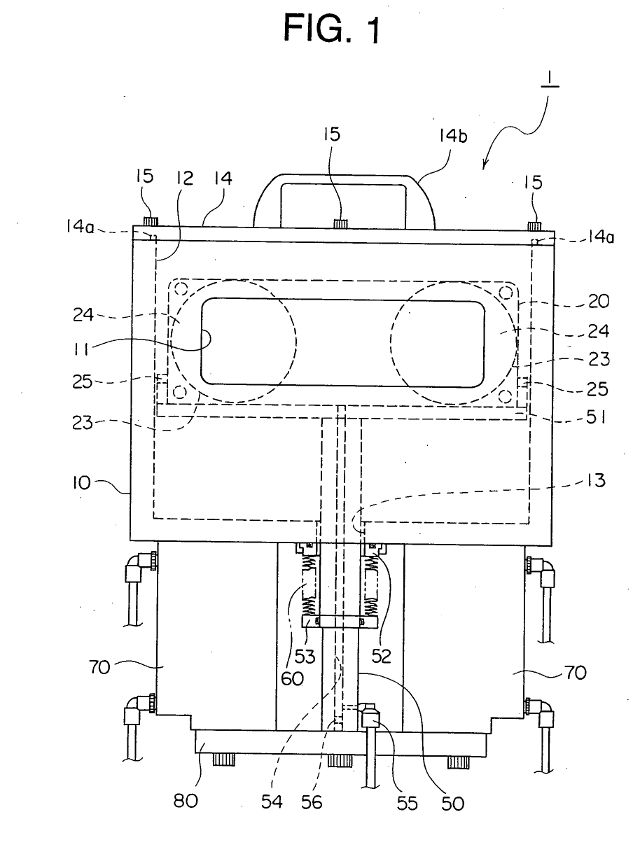

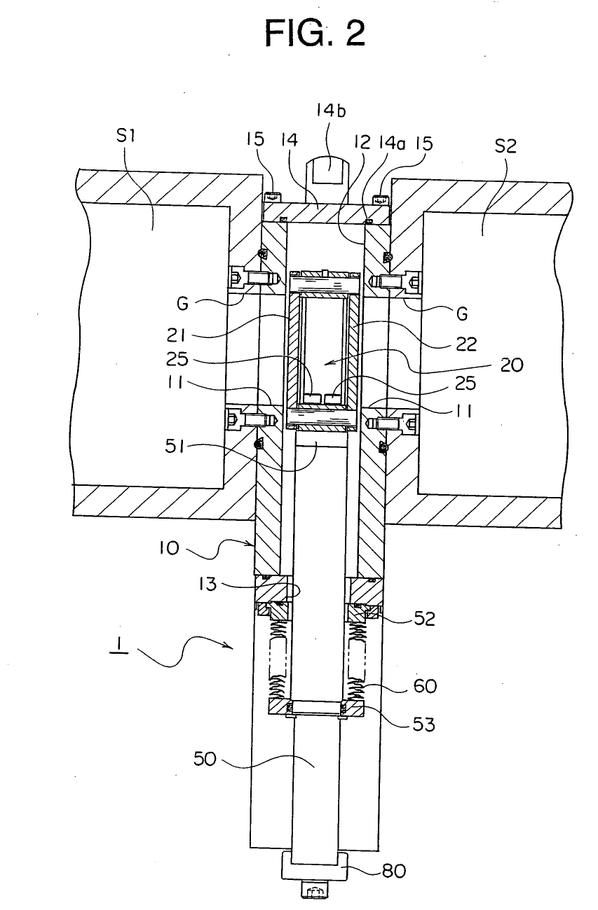

The gate valve 1 according to an embodiment of the present invention, as shown in FIG. 1 and FIG. 2, is provided with a valve case 10 formed with through holes 11 at facing positions, a valve assembly 20 having a pair of valve plates 21 and 22 connected through bellows 23 and arranged inside this valve case 10, a support rod 50 for supporting this valve assembly 20 at its front end, a bellows 60 for sealing the valve case 10 side and support rod 50 side, and air cylinders 70 for making the valve assembly 20 move between the open position and closed position through the support rod 50.

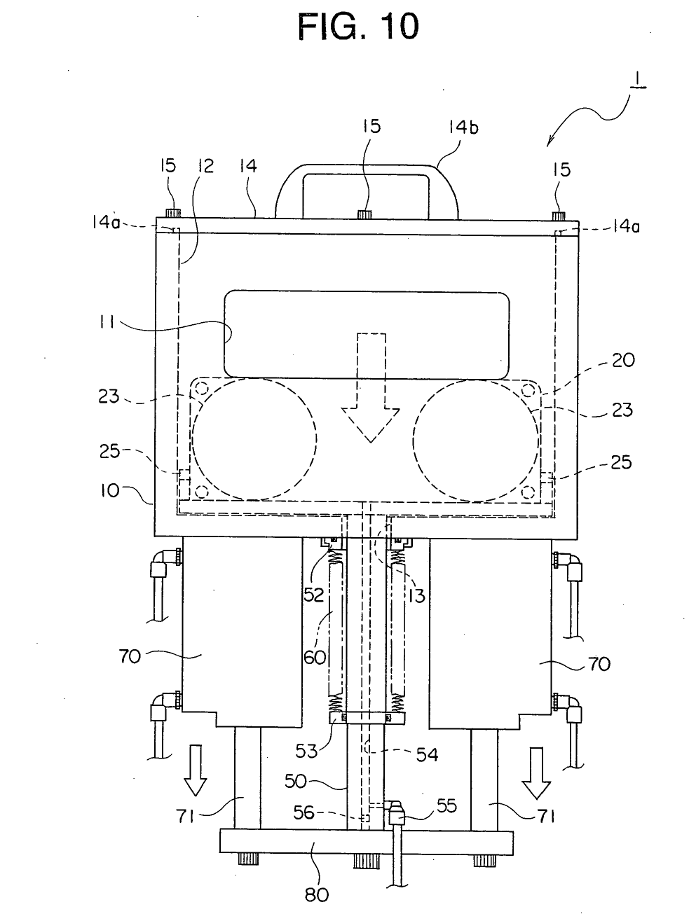

This gate valve 1 is, for example, as shown in FIG. 2, provided between vacuum process chambers Si and S2 in a semiconductor production process. The support rod 50 enables the valve assembly 20 to move between the open position shown in FIG. 10 and the closed position shown in FIG. 1. Further, this gate valve 1 supplies compressed air to the valve assembly 20 positioned at the closed position from an air supply device 101 or discharges compressed air from the valve assembly 20 positioned at the closed position by a vacuum pump 103 (explained later) so as to enable the pair of valve plates 21 and 22 to be pressed against or separated from the circumferences of the through holes 11, whereby it becomes possible to open or close the gates G of the vacuum process chambers S1 and S2.

The valve case 10 of the gate valve 1 according to the present embodiment, as shown in FIG. 1 and FIG. 2, is a box-shaped member having an inside space able to house the valve assembly 20. This valve case 10 is formed with two rectangular through holes 11 at facing positions.

The top surface of this valve case 10 is formed with an opening 12 of a size enabling the valve assembly 20 housed inside it to be taken out. Further, a lid 14 is detachably attached to the top surface of this valve case 10 by bolts 15 so as to close that opening 12. The bottom surface of this lid 14 is provided with an O-ring 14a matching with the contour of the opening 12. Due to this, when the opening 12 is closed by the lid 14, the air-tightness of the valve case 10 is secured. Further, the top surface of this lid 14 is provided with a handle 14b. Due to this, at the time of maintenance of the gate valve 1, the lid 14 can be easily detached from the valve case 10.

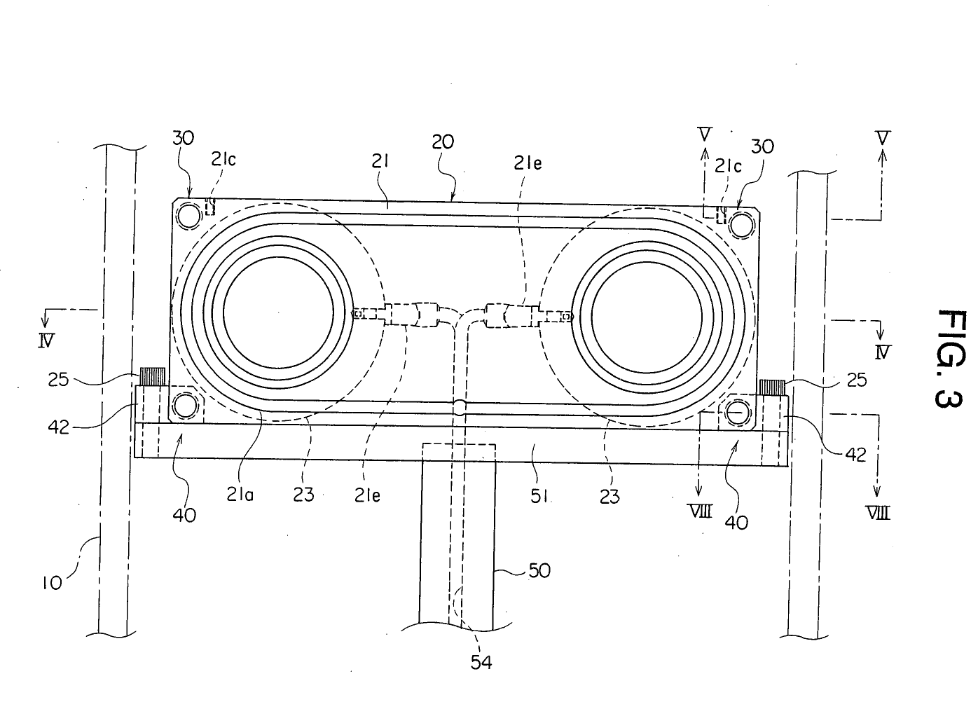

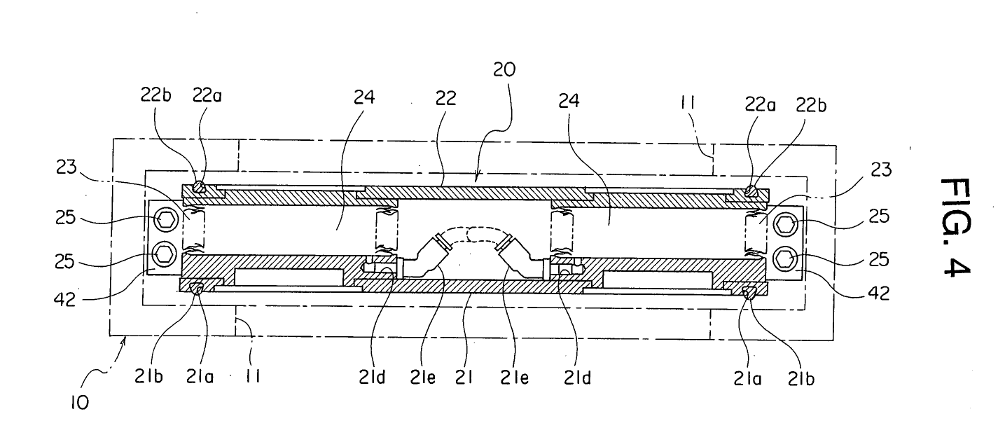

The valve assembly 20 of the gate valve 1 according to the present embodiment, as shown in FIG. 3 and FIG. 4, is comprised of a pair of valve plates 21 and 22, two bellows 23 for connecting the valve plates 21 and 22, and first and second guiding means 30 and 40 for preventing malfunction of the bellows 23.

The first valve plate 21 of this valve assembly 20 is a flat plate-shaped member larger than the corresponding through hole 11 of the valve case 10. The surface of this first valve plate 21 is formed with a groove 21a elliptically. The groove 21a of this first valve plate 21 has an O-ring 21b fit into it. Due to this, when this first valve plate 21 presses against the valve case 10, this O-ring 21b enables the through hole 11 to be sealed.

Similarly, the second valve plate 22 is also a flat plate-shaped member larger than the corresponding through hole 11 of the valve case 10. The surface of this second valve plate 22 is formed with a groove 22a elliptically. The groove 22a of this second valve plate 22 has an O-ring 22b inserted in it. Due to this, when this second valve plate 22 presses against the valve case 10, this )-ring 22b enables the through hole 11 to be sealed.

These valve plates 21 and 22 are both made from metal materials etc., but when the gate valve is used as a gate valve of a semiconductor production process, they are preferably made of materials not generating much particles and not emitting any gas.

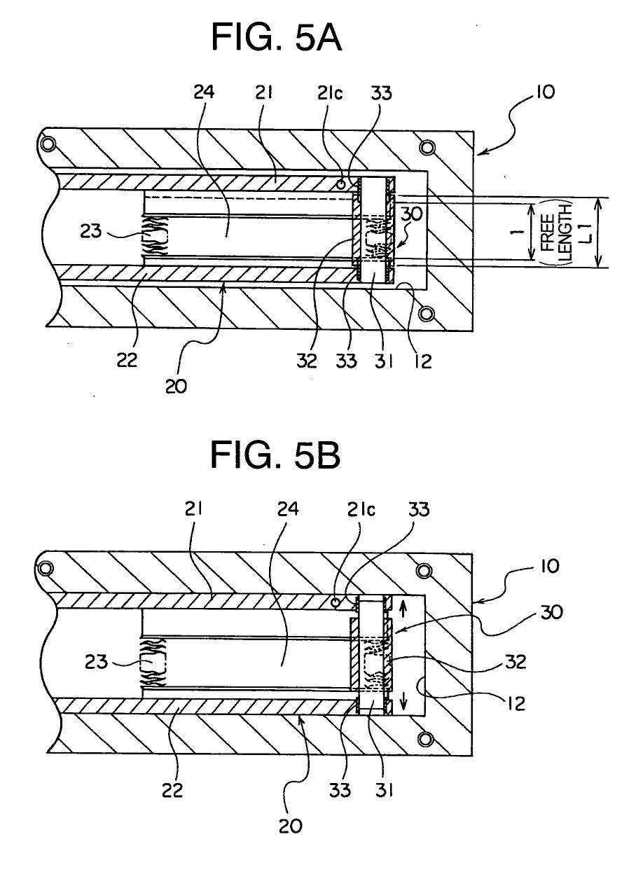

Further, the first valve plate 21 in the present embodiment, as shown in FIG. 3, FIG. 5A and FIG. 5B, is formed with internal threads 21c, into which external threads formed at the front ends of tools T (explained later) may be screwed, at two locations on its top surface. Hereby, it is no longer necessary to secure in the valve case 10 a space for insertion of the hand for example, so the gate valve 1 can be reduced in size.

The bellows 23 of the valve assembly 20, as shown in FIG. 3 and FIG. 4, are cylindrical accordion shaped metal members connecting the first valve plate 21 and second valve plate 22 in an extendable/contractile manner. The bellows 23, for maintaining air-tightness, are joined to the first valve plate 21 and second valve plate 22 for example by welding etc. The first valve plate 21, second valve plate 22, and bellows 23 form sealed spaces 24. The sealed spaces 24, as shown in FIG. 4, are communicated with connectors 21e through channels 21d formed in the first valve plate 21. Air supplied through the channels 21d to the sealed spaces 24 causes the bellows 23 to expand and extend to make the pair of valve plates 21 and 22 move apart and press the valve plates 21 and 22 against the circumferences of the through holes 11 of the valve case 10.

Note that in the present embodiment, as shown in FIG. 3 and FIG. 4, by using two cylindrically shaped bellows 23, two sealed spaces 24 are formed between the pair of valve plates. While not particularly limited to this in the present invention, the number of the bellows connecting the pair of valve plates can be freely set. For example, it is also possible to use a single substantially oval cylindrically shaped bellows to form a single sealed space between the pair of valve plates.

The guiding means 30 and 40 of the valve assembly 20 are both means for guiding the valve plates 21 and 22 along the direction in which the pair of valve plates 21 and 22 move away from or close to each other. As shown in FIG. 3, the first guiding means 30 are provided at the top two corners between the first valve plate 21 and second valve plate 22. The second guiding means 40 are provided at the bottom two corners. In the present embodiment, these guiding means 30 and 40 correspond to the guiding means and limiting means in the claims.

Each first guiding means 30, as shown in FIG. 5A, is comprised of a shaft 31 arranged between the pair of valve plates 21 and 22, a sleeve 32 into which this shaft 31 is inserted and fastened, and bushes 33 able to slide along the shaft 31 and provided at the valve plates 21 and 22.

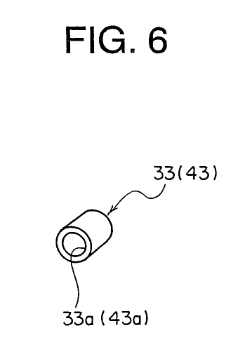

The bushes 33 of this first guiding means 30 are press-fit at the corner of the first valve plate 21 and the corner of the second valve plate 22. The bushes 33 are tubular members having inside holes 33a as shown in FIG. 6. The shaft 31 of each first guiding means 30 is arranged between the pair of valve plates 21 and 22 so that its axial direction substantially matches with the direction in which the valve plates 21 and 22 move away or close to each other. The both ends of this shaft 31 are inserted into the inside holes 33a of the bushes 33 press fit at the valve plates 21 and 22. The bushes 33, as shown in FIG. 5A and FIG. 5B, are designed to be able to slide with respect to that shaft 31 so as to make the pair of valve plates 21 and 22 move close to or away from each other. Note that the bushes 33, from the viewpoint of smoothening the sliding action on the shaft 31, preferably consist of polytetrafluoroethylene or another fluorocarbon resin material.

In this way, in the gate valve 1 according to the present embodiment, along with movement of the valve plates 21 and 22, the bushes 33 are made to slide on the shafts 31 and the pair of valve plates 21 and 22 are guided and supported in the direction moving close to or away from each other. Due to this, it becomes possible to prevent the weights of the valve plates 21 and 22 themselves from causing the bellows 23 to bend and buckle.

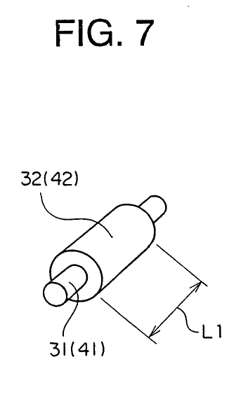

The sleeve 32 of each first guiding means 30, as shown in FIG. 7, has the shaft 31 inserted in it. A set screw (not shown) etc. is used to fasten the shaft 31 in place. The length L1 of this sleeve 32, as shown in FIG. 5A, is longer than the-free length 1 of the bellows 23 (L1>1). Due to this, it becomes possible to prevent the folds of a bellows 23 sandwiching foreign matter from coming into close contact and prevent the valve plates 21 and 22 from striking each other. Note that the free length of the bellows in the present invention is the length of the bellows along the direction of extension/contraction in the no-load state.

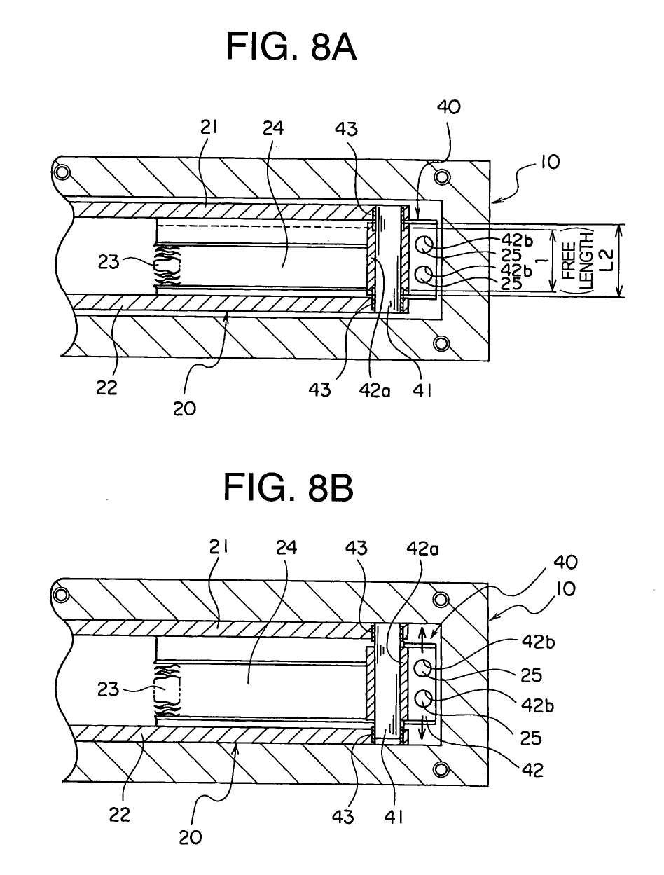

Each second guiding means 40, as shown in FIG. 8A, is comprised of a shaft 41 arranged between the pair of valve plates 21 and 22, a stopper block 42 which this shaft 41 is inserted into and fastened to, and bushes 43 able to slide along the shaft 41 and provided at the valve plates 21 and 22.

The bushes 43 of this second guiding means 40, in the same way as the above-mentioned bushes 33, are press-fit at two bottom corners of the first valve plate 21 and two bottom corners of the second valve plate 22. The bushes 43 are tubular members consisted of for example polytetrafluoroethylene or another fluorocarbon resin material (see FIG. 6).

The shaft 41 of each second guiding means 40, as shown in FIG. 8A and FIG. 8B, is arranged between the pair of valve plates 21 and 22 so that its axial direction substantially matches with the direction in which the valve plates 21 and 22 move away or close to each other. The both ends of this shaft 41 are inserted into the inside holes 43a of the bushes 43 press-fit at the valve plates 21 and 22. The bushes 43 are designed to be able to slide with respect to that shaft 41 so as to enable the pair of valve plates 21 and 22 to be moved close to or away from each other.

In this way, in the gate valve 1 according to the present embodiment, along with the operation of the valve plates 21 and 22, the bushes 43 slide on the shafts 41 and the pair of valve plates 21 and 22 are guided and supported in the direction moving close to or away from each other. Due to this, it becomes possible to prevent the weights of the valve plates 21 and 22 themselves from causing the bellows 23 to bend and buckle.

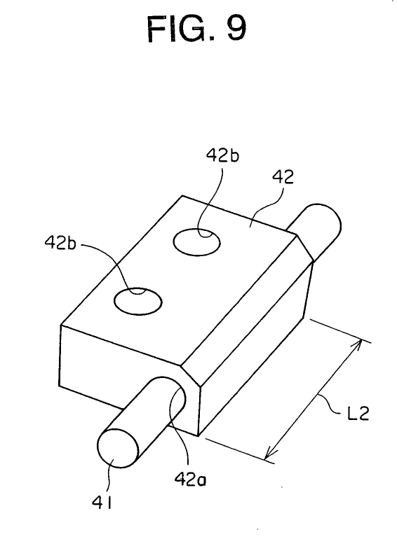

The stopper block 42 of each second guiding means 40, as shown in FIG. 9, has a shaft through hole 42a enabling insertion of the corresponding shaft 41. This stopper block 42 has the shaft 41 inserted into the shaft through hole 42a and fastened by a set screw (not shown) etc. Note that the length L2 of this stopper block 42, as shown in FIG. 8A, is longer than the free length 1 of the bellows 23 (L2>1). Due to this, it becomes possible to prevent the folds of the bellows 23 sandwiching foreign matter from coming into close contact and the valve plates 21 and 22 from striking each other.

Further, this stopper block 42, as shown in FIG. 9, is formed with bolt holes 42b enabling insertion of bolts 25 for fastening the valve assembly 20 to a connecting member 51 of the support rod 50. The bolt holes 42b are formed at lateral positions of each stopper block 42 with respect to the valve plates 21 and 22 or at positions of each stopper block 42 not interfering with the bellows 23, 23 when forming the valve assembly 20. Due to this, as shown in FIG. 4, it becomes possible to visually confirm the bolts 25 inserted into the bolt holes 42b through the opening 12 of the valve case 10.

In this way, in the gate valve 1 according to the present embodiment, the stopper blocks 42 of the second guiding means 40 of the valve assembly 20 are also provided with fastening means for fastening the valve assembly 20 to the support rod 50. Due to this, it becomes possible to reduce the number of parts forming the gate valve 1 and reduce the size of the gate valve 1.

One end of the support rod 50 of the gate valve 1 according to the present embodiment, as shown in FIG. 1 and FIG. 3, is fastened through the connecting member 51 and stopper blocks 42 to the valve assembly 20 by the bolts 25. Therefore, this support rod 50 is provided so that one end projects out inside the valve case 10 through a rod through hole 13 formed at the bottom of the valve case 10 and the inside hole of a top ring member 52 attached to the bottom of the valve case 10 through the O-ring.

As opposed to this, the other end of the support rod 50, as shown in FIG. 1, is fastened by bolting etc. to a connecting plate 80 which each front end of piston rods 71 of air cylinders 70 (later explained) is fastened to. Note that this support rod 50 consists of stainless steel or another metal material, but when the gate valve is used in a semiconductor production process, it is desirably made of a material not producing much particles and not emitting any gas.

Further, the inside of this support rod 50, as shown in FIG. 3, is formed with a channel 54 passing through it in the axial direction. One end of this channel 54 is connected through tubes to the connectors 21e of the first valve plate 21. The other end of this channel 54, as shown in FIG. 1, is connected to a connector 55 attached sealed to the support rod 50. Therefore, this connector 55 is communicated with the sealed spaces 24 of the valve assembly 20 through the channel 54 formed in the support rod 50. Note that the bottom end of this channel 54 is closed by a plug 56.

The bellows 60 of the gate valve 1 according to the present embodiment is a metal member for sealing the valve case 10 side and support rod 50 side. As shown in FIG. 1 and FIG. 2, one end of this bellows 60 is joined by for example welding or the like to the top ring member 52 fastened to the bottom of the valve case 10 through an O-ring while maintaining the air-tightness. The other end of this bellows 60 is joined by for example welding etc. to a bottom ring member 53 engaged with the support rod 50. Note that an O-ring is interposed between the bottom ring member 53 and the support rod 50. Due to this, even if the support rod 50 directly moves, it is possible to seal the valve case 10 and possible to prevent particles or other pollutants from entering from the outside.

The two air cylinders 70 of the gate valve 1 according to the present embodiment, as shown in FIG. 1 and FIG. 2, are both fastened to the bottom of the valve case 10 by bolting etc. and are arranged at symmetrical positions about the support rod 50. The air cylinders 70, as shown in FIG. 10, house piston rods 71 operating to extend and contract by air pressure. The front ends of these piston rods 71 are fastened to the connecting plate 80 by bolting etc. Further, by the piston rods 71 of the air cylinders 70 extending in the direct drive direction, as illustrated, through the connecting plate 80 and support rod 50, the valve assembly 20 can move back and forth between the open position and closed position. Note that the position of the valve assembly 20 shown in FIG. 1 is the closed position. As opposed to this, the position of the valve assembly 20 shown in FIG. 10 is the open position.

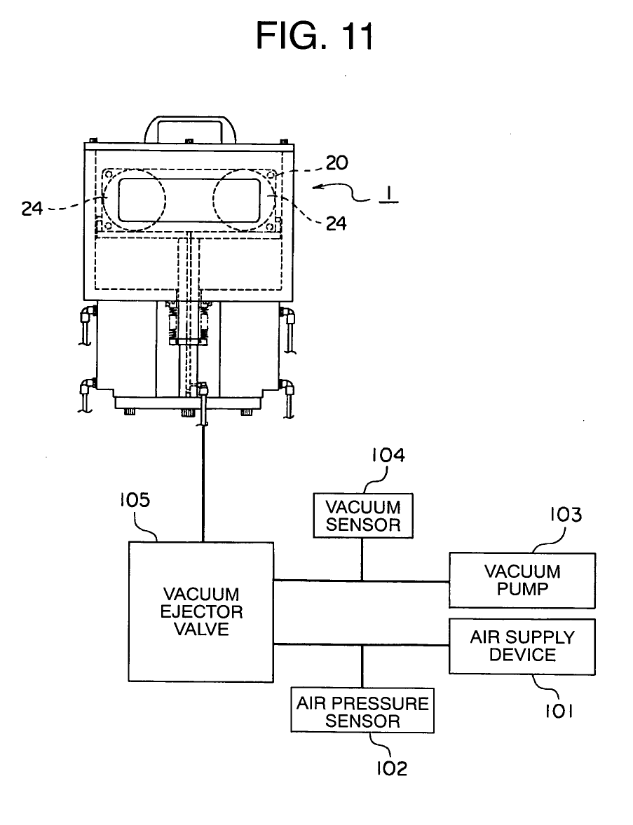

Next, explaining the piping system of the gate valve 1 according to the present embodiment, the piping system of this gate valve 1, as shown in FIG. 11, is comprised of an air supply device 101 for supplying compressed air to the sealed spaces 24 of the valve assembly 20, an air pressure sensor 102 for detecting the pressure in the sealed spaces 24 when supplying compressed air by the air supply device 101, a vacuum pump 103 for reducing the sealed spaces 24 of the valve assembly 20 to a vacuum, a vacuum sensor 104 for detecting the pressure inside the sealed spaces 24 reduced in pressure by the vacuum pump 103, and a vacuum ejector valve 105 for switching the air supply device 101 and vacuum pump 103. In the present embodiment, this piping system corresponds to the valve plate driving means and fluid supplying means in the claims.

Further, in the piping system of this gate valve 1, the vacuum ejector valve 105 is connected to the connector 55 of the support rod 50 through a tube. And the air supply device 101 and the vacuum pump 104 are connected to this vacuum ejector valve 105 separately. Also the air pressure sensor 102 is connected between the vacuum ejector valve 105 and air supply device 101, and the vacuum sensor 104 is connected between that valve 105 and the vacuum pump 103. Note that the compressed air for driving the air cylinders 70 is supplied from a not illustrated device separate from the air supply device 101. Next, the operation of the gate valve 1 according to the present embodiment will be explained.

When the valve assembly 20 closes the through holes 11 of the valve case 10 from the state in the open position, as shown in FIG. 1, the air cylinders 70 are supplied with compressed air, whereby the piston rods 71 contract and the connecting plate 80 rises. Along with this, the support rod 50 rises, so the valve assembly 20 moves to the closed position and the pair of valve plates 21 and 22 face the through holes 11 of the valve case 10.

At that time, in the gate valve 1 according to the present embodiment, the sealed spaces 24 of the valve assembly 20 are reduced to a vacuum by the vacuum pump 103 so that the pressure in the valve case 10 and the pressure inside the sealed spaces 24 become the same. In this state, the vacuum states of the sealed spaces 24 of the valve assembly 20 are monitored by the vacuum sensor 104.

When the inside of the valve case 10 is in the vacuum state, but the pressure inside the sealed spaces 24 of the valve assembly 20 is not the vacuum state, the differential pressure between the inside of the valve case 10 and the inside of the sealed spaces 24 acts in a direction against the elasticity of the bellows 23, whereby the valve plates 21 and 22 move apart, that is, in a direction making the bellows 23 extend, so the O-rings 21b and 22b of the valve plates 21 and 22 are liable to contact the inside walls of the valve case 10. As opposed to this, in the present embodiment, as shown in FIG. 4, the pressure inside the sealed spaces 24 of the valve assembly 20 is made the same as the pressure inside the valve case 10 in vacuum state, so it becomes possible to prevent the O-rings 21b and 22b of the valve plates 21 and 22 from contacting the inside walls of the valve case 10.

When the valve assembly 20 moves to the closed position, the vacuum ejector valve 105 is switched to enable the air supply device 40 to supply compressed air. The air supply device 101 supplies the sealed spaces 24 of the valve assembly 20 with compressed air to make the bellows 23 expand and extend, whereby the pair of valve plates 21 and 22 of the valve assembly 20 move away from each other, the valve plates 21 and 22 are pressed against the circumferences of the through holes 11 of the valve case 10, and the through holes 11 of the valve case 10 are sealed. In this state, the pressurized state of the sealed spaces 24 of the valve assembly 20 is monitored by the air pressure sensor 102.

When the valve plates 21 and 22 move apart from each other, as shown in FIG. 5A, FIG. 5B, FIG. 8A and FIG. 8B, the bushes 33 and 43 press fit at the valve plates 21 and 22 slide on and support the shafts 31 and 41 to guide the approach of the valve plates 21 and 22. Due to this, it is possible to prevent the weights of the valve plates 21 and 22 themselves from causing the bellows 23 to bend and buckle and possible to accurately press the valve plates 21 and 22 toward the circumferences of the through holes 21 and possible to reliably secure the desired air-tightness.

Incidentally, when dealing with reverse pressure by a single-sided sealing system using a cam mechanism etc., that is, when the back pressure due to the vacuum acts on the valve element, it is necessary to increase the rigidity of the gate valve, so enlargement of the gate valve is invited. As opposed to this, in the gate valve 1 according to the present embodiment, sealing by the both surfaces of the valve assembly 20 is possible, so it becomes possible to handle both forward pressure and reverse pressure by a compact structure.

When opening the through holes 11 of the valve case 10, the vacuum ejector valve 105 is switched so that the vacuum pump 103 can operate, the vacuum pump 103 reduces the pressure in the sealed spaces 24 of the valve assembly 20, and the elasticity of the bellows 23 causes the pair of valve plates 21 and 22 to move close to each other and separate the valve plates 21 and 22 from the circumferences of the through holes 11 of the valve case 10 to open the through holes 11 of the valve case 10.

At the time when these valve plates 21 and 22 approach each other, as shown in FIG. 5A, FIG. 5B, FIG. 8A and FIG. 8B, the distance between the valve plates 21 and 22 is limited by the sleeves 32 and stopper blocks 42 so as not to become less than the free length of the bellows 23. Due to this, it is possible to prevent folds of the bellows 23 sandwiching foreign matter from closely contacting and thereby damaging each other and to prevent the valve plates 21 and 22 from striking and damaging each other, whereby an increase of the service life of the valve assembly 20 becomes possible.

Further, the vacuum pump 104 reduces the pressure inside the sealed spaces 24 of the valve assembly 20 to a vacuum state. When the pressure inside that sealed spaces 24 and the pressure inside the valve case 10 become the same, the piston rods 71 of the air cylinders 70 extend to cause the connecting plate 80 to descend. Due to this, the support rod 50 descends and moves the valve assembly 20 to the open position. At that time, in the same way as above, by making the pressure inside the sealed spaces 24 of the valve assembly 20 the same as the pressure inside the valve case 10 in vacuum state, it becomes possible to prevent the O-rings 21b and 22b of the valve plates 21 and 22 from contacting the inside walls of the valve case 10. Next, the method of maintenance of the gate valve 1 according to the present embodiment will be explained.

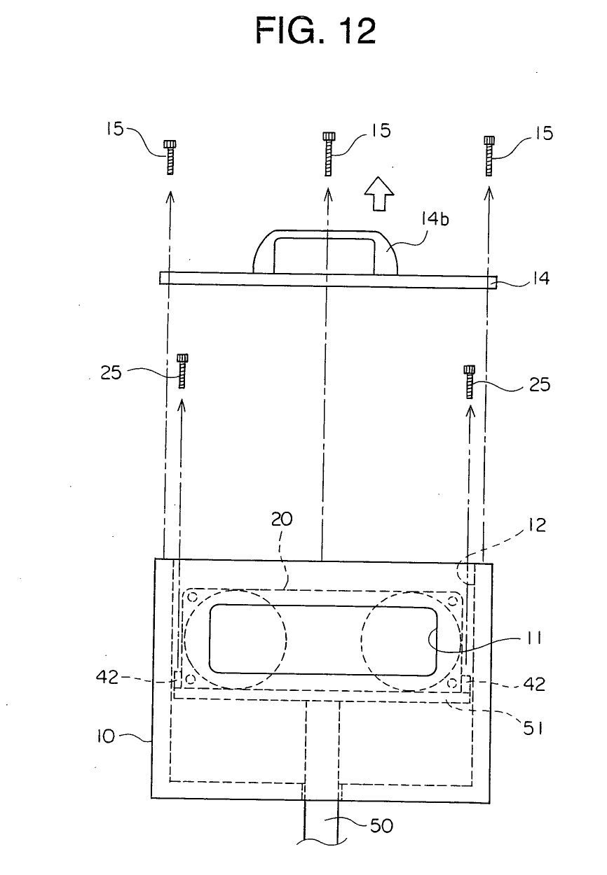

First, the tubes connected to the channel 54 of the support rod 50 are detached from the connectors 21e of the first valve plate 21, as shown in FIG. 12, the bolts 15 fastening the lid 14 to the valve case 10 are loosened, and the lid 14 is detached from the valve case 10 to open the opening 12 of the valve case 10. At that time, since the lid 14 is provided with a handle 14b, it becomes possible to easily detach the lid 14 from the valve case 10.

Next, a wrench is inserted from this opening 12 to the inside of the valve case 10. This wrench is used to loosen the bolts 25 fastening the valve assembly 20 to the support rod 50 through the stopper blocks 42.

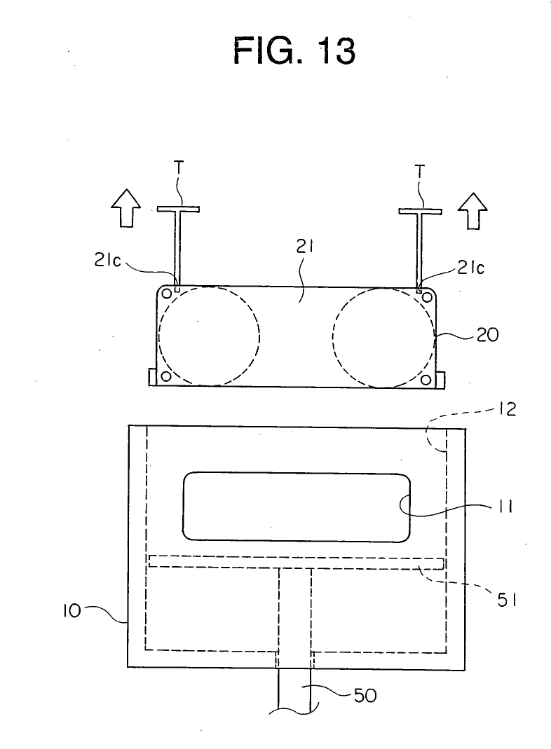

Next, two tools T formed with external threads at their front ends are inserted into the opening 12, the front ends of the tools T are engaged with the internal threads 21c formed at two locations on the top surface of the first valve plate 21, and, as shown in FIG. 13, the tools T are pulled up to remove the valve assembly 20 from the valve case 10. In this way, in the gate valve 1 according to the present embodiment, it is possible to use tools T able to engage with the internal threads 21c provided at the first valve plate 21 so as to easily remove the valve assembly 20 from the valve case 10.

The O-rings 21b and 22b of the valve plates 21 and 22 of the removed valve assembly 20 are replaced, the valve assembly 20 is cleaned, then the tools T are used to reinsert the valve assembly 20 through the opening 12 into the valve case 10 and place that valve assembly 20 on the connecting member 51 of the support rod 50.

Next, a wrench is inserted through the opening 12. This wrench is used to tighten the bolts 25 to fasten the valve assembly 20 to the support rod 50 through the stopper blocks 42.

Next, the tubes connected to the channel 54 of the support rod 50 are reconnected to the connectors 21e, then the opening 12 of the valve case 10 is closed by the lid 14 and the bolts 15 are tightened to fasten the lid 14 to the valve case 10, whereby the maintenance is completed.

In the above way, in the gate valve 1 according to the present embodiment, at the time of maintenance, only the valve assembly 20 is taken out through the opening 12 from the valve case 10. Due to this, it becomes possible to easily perform maintenance on the gate valve without disassembling the gate valve as a whole.

Note that the embodiments explained above were described for facilitating the understanding of the present invention and were not described for limiting the present invention. Accordingly, the components disclosed in the above embodiments include all modifications in designs and equivalents belonging to the technical field of the present invention.

1. A gate valve comprising at least:
a valve case formed with through holes at facing positions;
a valve assembly having a pair of valve plates arranged in said valve case and bellows connecting said pair of valve plates;
a support rod for supporting said valve assembly and making said valve assembly move between a closed position where said valve plates face said through holes and an open position where said valve plates do not face said through holes;
a valve plate driving means for making said pair of valve plates move away from or close to each other; and
guiding means for guiding said valve plates along a direction in which said pair of valve plates move away from or close to each other; wherein
said valve plate driving means is a fluid supplying means for supplying a fluid to a sealed space formed by said pair of valve plates and said bellows and discharging said fluid from said sealed space,
said valve case is formed with an opening through which said valve assembly can be passed and provided with a lid detachably attached to said valve case so as to close said opening, and
said valve assembly can be attached to or detached from said support rod through said opening.

2. A gate valve as set forth in claim 1, wherein:
each said guiding means includes
a shaft arranged between said pair of valve plates and
bushes able to slide along said shaft and provided at said valve plates,
an axial direction of said shaft substantially matching a direction in which said pair of valve plates move away from or close to each other,
said valve assembly further having limiting means for limiting a distance of approach at the time of approach of said pair of valve plates so that folds of said bellows will not come into contact at the time of contraction.

3. A gate valve as set forth in claim 2, wherein:
each said limiting means includes a sleeve and a stopper block having lengths longer than the free length of said bellows so that said distance of approach between said pair of valve plates limited by said limiting means becomes longer than a free length of said bellows, and
said sleeve and stopper block are fastened to said shaft.

4. A gate valve as set forth in claim 2, wherein:
each said limiting means includes a stopper block for holding said shaft,
said stopper block is detachably connected with said support rod so that the valve assembly can be attached to or detached from said support rod, and
the attachment or detachment of said stopper block with respect to said support rod enables work through the opening of said valve case.

5. A gate valve as set forth in claim 3, wherein:
each said limiting means includes a stopper block for holding said shaft,
said stopper block is detachably connected with said support rod so that the valve assembly can be attached to or detached from said support rod, and
the attachment or detachment of said stopper block with respect to said support rod enables work through the opening of said valve case.
